(19) United States
(12) Patent Application Publication
(10) Pub. No.: US 2005/0036082 A1
(43) Pub. Date: Feb. 17, 2005

(54) Electro-optical crystal light shutter preventing motion picture blurring in a liquid crystal display

(75) Inventor: Chi-Kuang Lai, Taoyuan County (TW)

Correspondence Address: Finnegan, Henderson, Farabow,;Garrett & Dunner, L.L.P., 1300 I Street, N.W., Washington, DC, 20005-3315, US

(73) Assignee: HannStar Display Corporation.

(21) Appl. No.: 10/736,636

(22) Filed: Dec. 17, 2003

(30) Foreign Application Priority Data
Aug. 11, 2003 (TW) 092122030

(51) Int. Cl. G02F 1/1335

(52) U.S. Cl. 349/61

(57) ABSTRACT

A liquid crystal display (LCD) that comprises a backlight source, an electro-optical light shutter (EOLS) including a plurality of regions arranged in a pattern, and during a frame time controlling light from the backlight source to pass the regions in a display time that allows the LCD to display an image, and an LCD panel disposed to sandwich the EOLS with the backlight source receiving the light passing through the EOLS to display the image.

### FIELD OF THE INVENTION

This invention relates in general to a liquid crystal display (“LCD”) and, more particularly, to an LCD including an electro-optical light shutter.

### BACKGROUND OF THE INVENTION

Display devices in the art may generally be divided into impulse-type displays and hold-type displays according to their principles of display. An impulse-type display, for example, a cathode ray tube (“CRT”) display, provides luminance signals in the form of a serial of impulses in displaying an image. The image exists for a relatively short time during a frame time.

On the other hand, a hold-type display, for example, a liquid crystal display (“LCD”), provides luminance signals in the form of a serial of square waves in displaying an image. The image displayed by a hold-type display exists longer than that displayed by an impulse-type display during a frame time. The longer display time may result in problems of edge blurring in particular in displaying an image of a motion picture. As a result, hold-type displays do not produce as good display performance as impulse-type displays.

LCDs have been widely used in electronic products such as mobile phones, video cameras, desktop displays and notebook computers. To resolve edge blurring, it is necessary to reduce the display time of an image during a frame time so as to enhance the display quality of motion pictures.

Conventional techniques in the art for resolving edge blurring generally include a scanning backlight approach and a blinking backlight approach. The scanning backlight approach turns on or turns off a plurality of backlight lamps formed in parallel to each other in sequence during a frame time to generate an effect of backlight-scanning an image in an effort to reduce a display time of the image during the frame time. Such an approach has an emulated effect of a CRT display which in operation principle displays an image by scanning electronic beams over a CRT screen. Although the backlight scanning approach is able to solve the problems of edge blurring, a new issue of higher power consumption may arise in switching between the on/off states of the backlight lamps. Another issue may also arise in the response speed of the backlight lamps. The backlight lamps used in the scanning backlight approach are expected to respond faster than general backlight lamps. However, backlight lamps with a faster response time are not reliable enough to meet commercial needs. Still another issue may also arise in the sharpness of an image in display in that light emitted from an on-state lamp may scatter onto the regions to be illuminated by adjacent lamps which are currently turned off.

The blinking backlight approach turns on or turns off a plurality of backlight lamps at a same time in an effort to reduce a display time of an image during a frame time. In such an approach, however, it is required to charge transistors of an LCD to a required level while switching all of the backlight lamps from an off-state to an on-state. As a result, the backlight lamps must have a fast response time. Besides, the blinking backlight approach also controls the on/off states of backlight lamps to reduce the display time of an image, and may thus have relatively high power consumption.

Although the scanning backlight approach and the blinking backlight approach may overcome the problems of edge blurring, both approaches require backlight lamps with a fast response time. As mentioned above, such backlight lamps are not reliable enough. Besides, both approaches have complex circuit control systems and relatively high power consumption due to switching between the on/off states of backlight lamps. It is generally desirable to have more effective approaches in the art to overcome the edge blurring problems.

### SUMMARY OF THE INVENTION

Accordingly, the present invention is directed to liquid crystal displays that obviate one or more of the problems due to limitations and disadvantages of the related art.

An object of the present invention is to provide a liquid crystal display (“LCD”) including an electro-optical light shutter (“EOLS”) to reduce a display time of an image during a frame time.

Another object of the present invention is to provide an LCD including an EOLS that has an emulated effect of a scanning backlight LCD to solve the edge blurring problems in displaying an image of a motion picture with simplified circuit control and less power consumption.

Still another object of the present invention is to provide an LCD including an EOLS that has an emulated effect of a scanning backlight LCD to solve the edge blurring problems in displaying an image of a motion picture without incurring the issue of light scattering on adjacent regions.

Further still another object of the present invention is to provide an LCD including an EOLS that has an emulated effect of a blinking backlight LCD to solve the edge blurring problems in displaying an image of a motion picture.

To achieve these and other advantages, and in accordance with the purpose of the invention as embodied and broadly described, there is provided an LCD that comprises a backlight source, an EOLS including a plurality of regions arranged in a pattern, and during a frame time controlling light from the backlight source to pass the regions in a display time that allows the LCD to display an image, and an LCD panel disposed to sandwich the EOLS with the backlight source receiving the light passing through the EOLS to display the image.

In one aspect, the EOLS further comprises a first substrate, a first electrode layer on the first substrate further comprising a plurality of transparent electrodes formed in parallel to each other, a second substrate opposing the first substrate, a second electrode layer on the second substrate, and a liquid crystal (LC) layer between the first and second electrode layers.

In another aspect, the LC layer further comprises ferroelectric LC.

Also in accordance with the present invention, there is provided an LCD that comprises a first polarizer, a first substrate on the first polarizer, a first electrode layer on the first substrate further comprising a plurality of transparent electrodes formed in parallel to each other, a second substrate opposing the first a second electrode layer on the second substrate, a first liquid crystal (LC) layer between the first and second electrode layers, a second polarizer on the second substrate, a third substrate over the second polarizer, a second LC layer between the second polarizer and the third substrate, and a third polarizer on the third substrate.

Still in accordance with the present invention, there is provided an LCD that comprises a first polarizer, a first substrate on the first polarizer, a first electrode layer on the first substrate further comprising a plurality of transparent electrodes formed in parallel to each other, a second substrate opposing the first substrate, a second electrode layer on the second substrate, a first liquid crystal (LC) layer between the first and second electrode layers, a second polarizer between the first LC layer and the second electrode layer, a third substrate over the second substrate, a second LC layer between the second and third substrates, and a third polarizer on the third substrate.

Yet still in accordance with the present invention, there is provided a method of operating a liquid crystal display (LCD) that comprises providing a backlight source, emitting light from the backlight source, providing an electro-optical light shutter (EOLS) including a first substrate, a first electrode layer on the first substrate further comprising a plurality of transparent electrodes formed in parallel to each other, a second substrate opposing the first substrate, a second electrode layer on the second substrate, and a liquid crystal (LC) layer between the first and second electrode layers, and selectively biasing the transparent electrodes to selectively allow the light from the backlight source to pass the EOLS during a frame time.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic cross-sectional view of a liquid crystal display (LCD) including an electro-optical light shutter (EOLS) in accordance with one embodiment of the present invention;

FIG. 2 is a schematic cross-sectional view of an EOLS in accordance with an additional embodiment of the present invention;

FIG. 3 is a schematic cross-sectional view of a thin film transistor LCD in accordance with another embodiment of the present invention;

FIG. 4 is a schematic cross-sectional view of a thin film transistor LCD in accordance with yet another embodiment of the present invention;

FIG. 5A is a schematic cross-sectional view of a thin film transistor LCD in accordance with still another embodiment of the present invention; and

FIG. 5B is a schematic cross-sectional view of a thin film transistor LCD in accordance with yet still another embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

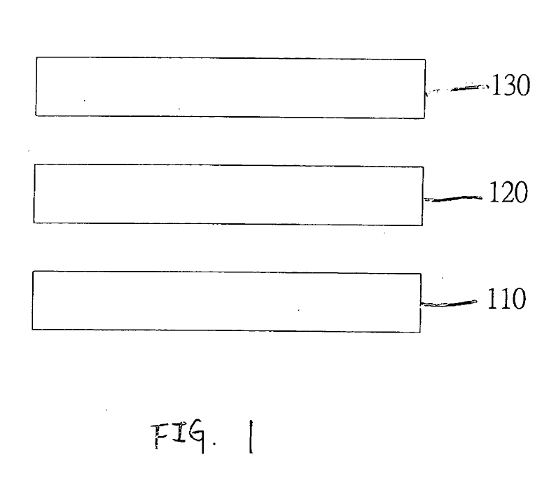

FIG. 1 is a schematic cross-sectional view of a liquid crystal display (LCD) including an electro-optical light shutter (EOLS) in accordance with one embodiment of the present invention. The LCD (not numbered) includes a backlight source 110, an electro-optical light shutter (EOLS) 120 and an LCD panel 130. Light emitted from backlight source 110 passes through EOLS 120 to LCD panel 130 to illuminate an image displayed on LCD panel 130. EOLS 120 turns on to become on-state or turns off to become off-state to control whether the light reaches LCD panel 130. The duration of the on-state or off-state controls a display time of an image during a frame time. EOLS 120 may include a solid-state crystal or a liquid crystal.

For the purpose of discussion, a liquid crystal EOLS together with its structure and operation principle is used as an example throughout the specification.

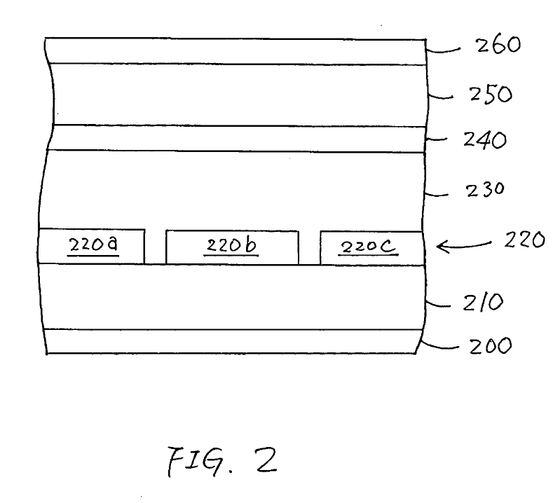

FIG. 2 is a schematic cross-sectional view of an EOLS in accordance with an additional embodiment of the present invention. The EOLS includes a first substrate 210, a first electrode layer 220, a liquid crystal (LC) layer 230, a second electrode layer 240 and a second substrate 250. Polarizer 200 and polarizer 260 are respectively provided on an outer surface (not numbered) each of first substrate 210 and second substrate 250. Polarizer 200 includes an absorption axis generally perpendicular to that of polarizer 260. First electrode layer 220 includes a plurality of transparent electrodes 220a, 220b and 220c formed in parallel to each other in a direction across an image in display. Each of transparent electrodes 220a, 220b and 220c includes-six-electrodes, and-may include as many as the line numbers of pixels included in an LCD panel to secure desirable display quality. In one embodiment according to the invention, first electrode layer 220 and second electrode layer 240 include indium tin oxide (“ITO”). First electrode layer 220 and second electrode layer 240 are exchangeable.

The EOLS in operation principle is similar to an LCD. When an external electric field is not applied to LC layer 230 sandwiched between the transparent electrodes of first electrode layer 220 and second electrode layer 240, LC molecules in LC layer 230 are horizontally arranged according to an upper and lower alignment films (not numbered) adjacent to LC layer 230. Each of the upper and lower alignment films has an aligning direction generally orthogonal to one another. Furthermore, since the absorption axes of polarizers 200 and 260 are generally perpendicular to each other, a polarized direction of a polarized light passing through polarizer 200 is also perpendicular to that of a polarized light passing through polarizer 260. The LC molecules rotate the polarized direction of an incident light to allow the incident light to pass the EOLS. If an external electric field is established by applying a voltage to LC layer 230 sandwiched between second electrode layer 240 and one of transparent electrodes, for example, electrode 220b, the LC molecules are vertically arranged to block the passage of an incident light.

As voltage is applied to the transparent electrodes of first electrode layer 220 to produce an emulated effect of a scanning backlight or blinking backlight, how and whether a region of an LCD panel is to be illuminated and the sequence and duration of illumination in different regions can now be advantageously controlled. Interference between an illuminated region-and its adjacent non-illuminated regions is advantageously avoided and light scattering further prevented. Since a desirable display quality of a motion picture generally requires a fast scan across an image, the EOLS will preferably include an LC material of a relatively fast response time, for example, approximately 10 to 20 microseconds. In one embodiment according to the present invention, the EOLS includes ferroelectric LC.

LCD panel 130 and EOLS 120 can include various combinations in configuration. Exemplary combinations of LCD panel 130 and EOLS 120 are discussed as follows.

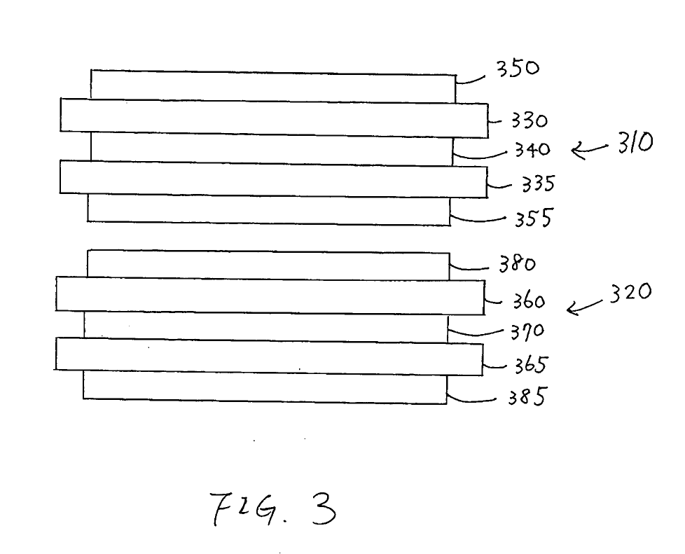

FIG. 3 is a schematic cross-sectional view of a thin film transistor LCD in accordance with another embodiment of the present invention. The LCD includes an LCD panel 310, an EOLS 320 and a backlight source (not shown) which are similar to those shown in FIG. 1.

LCD panel 310 includes a first substrate 330, a second substrate 335 and a first LC layer 340 sandwiched between first substrate 330 and second substrate 335. A first polarizer 350 and a second polarizer 355 are respectively provided on an outer surface each of first substrate 330 and second substrate 335. First polarizer 350 includes an absorption axis generally perpendicular to that of second polarizer 355. In one embodiment according to the invention, first substrate 330 includes a color filter formed thereon, and second substrate 350 includes a thin film transistor array formed thereon.

EOLS 320 includes a third substrate 360, a fourth substrate 365 and a second LC layer 370 sandwiched between third substrate 360 and fourth substrate 365. A third polarizer 380 and a fourth polarizer 385 are respectively provided on an outer surface each of third substrate 360 and fourth substrate 365. A first electrode layer (not shown) and a second electrode layer (not shown) are respectively provided on an inner surface each of third substrate 360 and fourth substrate 365. The first and second electrode layers are similar to those shown in FIG. 2, and are exchangeable. Third polarizer 380 includes an absorption axis generally perpendicular to that of fourth polarizer 385.

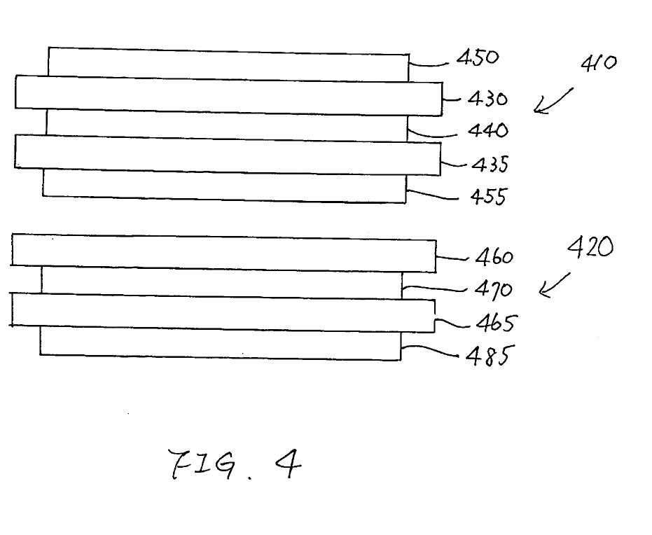

Referring again to FIG. 3, LCD panel 310 includes two polarizers 350 and 355 of which the absorption axes are perpendicular to one another. EOLS 320 also includes two polarizers 380 and 385 of which the absorption axes are perpendicular to one another. Assuming the absorption axes of the four polarizers 350, 355, 380 and 385 in order have a direction of x, y, y and x, respectively, or y, x, x and y, respectively, one of the two intermediate polarizers 355 and 380 including the absorption axes of the same y or x direction may be eliminated. As an example, an LCD shown in FIG. 4 includes only one intermediate polarizer 455, eliminating a third polarizer.

FIG. 4 is a schematic cross-sectional view of a thin film transistor LCD in accordance with yet another embodiment of the present invention. The LCD includes an LCD panel 410, an EOLS 420 and a backlight source (not shown) which are similar to those shown in FIG. 1.

LCD panel 410 includes a first substrate 430, a second substrate 435 and a first LC layer 440 sandwiched between first substrate 430 and second substrate 435. A first polarizer 450 and a second polarizer 455 are respectively provided on an outer surface each of first substrate 430 and second substrate 435. First polarizer 450 includes an absorption axis generally perpendicular to that of second polarizer 455. In one embodiment according to the invention, first substrate 430 includes a color-filter-on-array (“COA”) substrate, and second substrate 450 includes common electrodes formed thereon. In another embodiment, first substrate 430 includes a color filter formed thereon, and second substrate 450 includes a thin film transistor array formed thereon.

EOLS 420 includes a third substrate 460, a fourth substrate 465 and a second LC layer 470 sandwiched between third substrate 460 and fourth substrate 465. A fourth polarizer 485 is provided on an outer surface of fourth substrate 465. A first electrode layer (not shown) and a second electrode layer (not shown) are respectively provided on an inner surface each of third substrate 460 and fourth substrate 465. The first and second electrode layers are similar to those shown in FIG. 2, and are exchangeable. Fourth polarizer 485 includes an absorption axis generally perpendicular to that of second polarizer 455.

Although a polarizer is eliminated from third substrate 460 of EOLS 420, the contrast ratio of the LCD can still be maintained. Second polarizer 455 of LCD panel 410 may include either a general absorbing-type polarizer or a reflecting-type polarizer. In the case of a reflecting-type polarizer, second polarizer 455 includes a polarization conversion film to convert a polarized direction of light passing through EOLS 420 and then reflect the polarized light back to a backlight source. The polarized light is depolarized and then reflected to second polarizer 455, resulting in an increase in the total transmittance of light and in turn a reduction in power consumption of the backlight source. The particular embodiment shown in FIG. 4 solves the edge blurring problems and saves the power consumption of a backlight source as well.

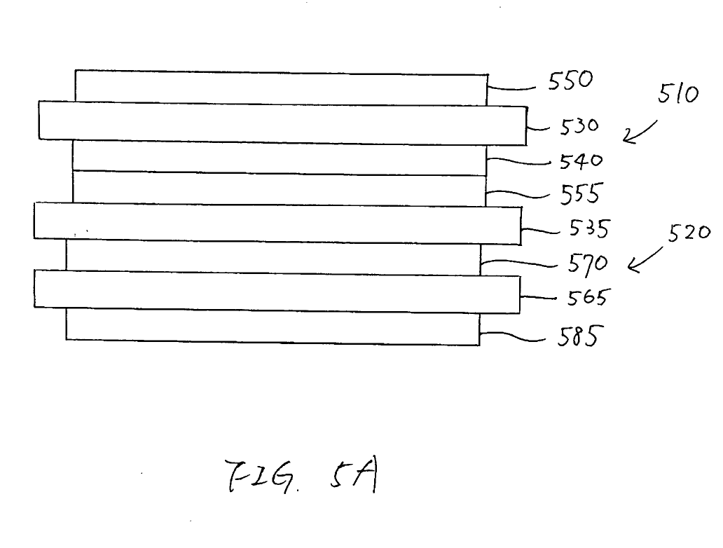

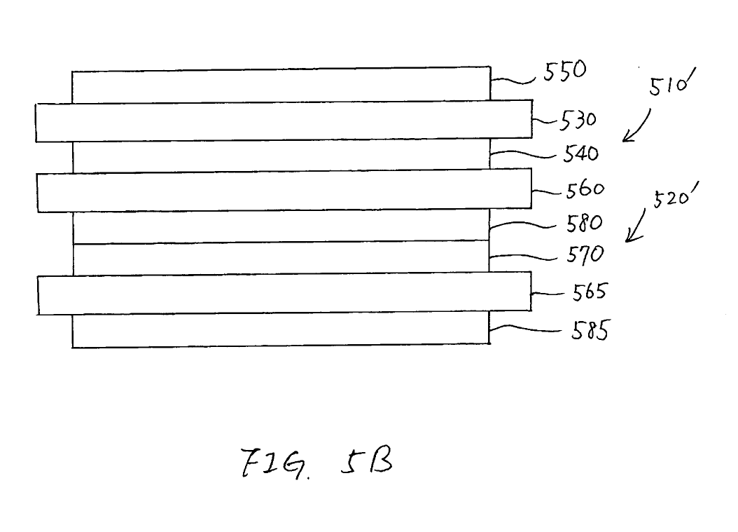

In the particular embodiment, the intermediate second polarizer 455 is provided on the outer surface of second substrate 435. In another embodiment, second polarizer 455 is provided between first LC layer 440 and second substrate 435, a similar structure to which is shown in FIG. 5A.

FIG. 5A is a schematic cross-sectional view of a thin film transistor LCD in accordance with still another embodiment of the present invention. The LCD includes an LCD panel 510, an EOLS 520 and a backlight source (not shown) which are similar to those shown in FIG. 1.

LCD panel 510 includes a first substrate 530, a second substrate 535, a first LC layer 540 and a second polarizer 555. First LC layer 540 and second polarizer 555 are sandwiched between first substrate 530 and second substrate 535. A first polarizer 550 is provided on an outer surface of first substrate 530. First polarizer 550 includes an absorption axis generally perpendicular to that of second polarizer 555. In one embodiment according to the invention, first substrate 530 includes a COA substrate, and second substrate 535 includes common electrodes formed thereon. In another embodiment, first substrate 530 includes a color filter formed thereon, and second substrate 535 includes a thin film transistor array formed thereon.

EOLS 520 uses second substrate 535 as an upper substrate, eliminating a third substrate as compared to EOLS 420 shown in FIG. 4. EOLS 520 therefore includes second substrate 535, a fourth substrate 565, a second LC layer 570 and a fourth polarizer 585. Second LC layer 570 is sandwiched between second substrate 535 and fourth substrate 465. Fourth polarizer 585 is provided on an outer surface of fourth substrate 565. Fourth polarizer 585 includes an absorption axis generally perpendicular to that of second polarizer 555. In one embodiment according to the invention, fourth polarizer 585 of EOLS 520 is provided between second substrate 535 and fourth substrate 585, a similar structure to which is shown in FIG. 5B.

FIG. 5B is a schematic cross-sectional view of a thin film transistor LCD in accordance with yet still another embodiment of the present invention. The LCD includes an LCD panel 510′, an EOLS 520′ and a backlight source (not shown) which are similar to those shown in FIG. 1.

EOLS 520′ includes a third substrate 560, a fourth substrate 565, a second LC layer 570 and a third polarizer 580. Second LC layer 570 is sandwiched between third substrate 560 and fourth substrate 565. A fourth polarizer 585 is provided on an outer surface of fourth substrate 565. A first electrode layer (not shown) and a second electrode layer (not shown) are respectively provided on an inner surface each of third substrate 560 and fourth substrate 565. The first and second electrode layers are similar to those shown in FIG. 2, and are exchangeable. Fourth polarizer 585 includes an absorption axis generally perpendicular to that of third polarizer 580.

LCD panel 510′ uses third substrate 560 as a lower substrate, eliminating a second substrate as compared to LCD panel 510 shown in FIG. 5A.

LCD panel 510′ therefore includes a first substrate 530, third substrate 560, a first LC layer 540 and a first polarizer 550. First LC layer 540 is sandwiched between first substrate 530 and third substrate 560. First polarizer 550 is provided on an outer surface of first substrate 530. First polarizer 550 includes an absorption axis generally perpendicular to that of third polarizer 580. In one embodiment according to the invention, first substrate 530 includes a COA substrate, and third substrate 560 includes common electrodes formed thereon. In another embodiment, first substrate 530 includes a color filter formed thereon, and third substrate 560 includes a thin film transistor array formed thereon.

The particular embodiments shown in FIGS. 5A and 5B can reduce the size and weight of an LCD. In one embodiment according to the invention, fourth substrate 585 of EOLS 520 and EOLS 520′ is made of a plastic material, which further reduces the weight of an LCD. Besides, EOLS 520 and EOLS 520′ are respectively combined with LCD panels 510 and 510′. The combined structure alleviates a potential issue that would otherwise occur in a non-combined structure in which light traveling between an EOLS and an LCD panel is dispersed due to reflection. The combination of an EOLS and an LCD panel may increase the total transmittance of light and in turn the magnitude of luminance of an LCD and save power consumption of a backlight source. As a result, the particular embodiments shown in FIGS. 5A and 5B solves the edge blurring problems, reduces the weight and size of an EOLS, and reduces the power consumption of a backlight source.

The present invention uses an EOLS to provide an emulated operation of a scanning backlight source and a blinking backlight source without switching the on/off states of these sources, thereby reducing power consumption. The EOLS includes an LC layer further including ferroelectric LC. The ferroelectric LC has a response time of generally 10 to 20 microseconds (ms), which is smaller than the response time, for example, at least 10 ms, of typical LCs for LC panels by generally 2 to 3 orders. Therefore, the ferroelectric LC is able to serve as an optical switch for an LC panel. The EOLS uses the LC layer as a light shutter such that the issue of light scattering on adjacent regions as would occur in the scanning backlight approach is avoided, thereby improving the display performance of an LCD.

The present invention can provide the advantages as follows. First, there is no need to control the on/off states of a backlight source, thereby reducing power consumption. In contrast, the scanning and blinking backlight approaches in the art reduce a display time of an image of a motion picture during a frame time by switching the on/off states of a backlight lamp. The backlight lamp consumes relatively high power in switching between the on/off states. The present invention uses an EOLS to advantageously achieve an emulated effect of the scanning backlight approach and the blinking backlight approach in providing a light source. Since it is not necessary to control the on/off states of a backlight source, the invention can advantageously save power.

Second, the EOLS includes an LC layer further including ferroelectric LC having a response time of generally 10 to 20 microseconds. When an electric field is applied to the ferroelectric LC sandwiched between an upper and lower electrode layers, the ferroelectric LC according to the present invention can quickly respond to change its molecule arrangement in order to control whether an incident light is allowed to pass. The EOLS advantageously functions to serve as a light shutter for an LCD panel.

Third, since the EOLS uses LC to serve as a light shutter, light scattering on non-illuminated regions adjacent to an illuminated region of an LCD panel is advantageously avoided. The edge blurring problems in the art are advantageously resolved, and the display quality of an LCD is optimized as well.

The present invention also provides a method of operating an LCD. A backlight source is provided. Light from the backlight source is emitted. An electro-optical light shutter (EOLS) is provided with a first substrate 210, a first electrode layer 220 on first substrate 210 further comprising a plurality of transparent electrodes 220a, 220b and 220c formed in parallel to each other, a second substrate 250 opposing first substrate 210, a second electrode layer 240 on second substrate 250, and a liquid crystal (LC) layer 230 between first and second electrode layers 220 and 240. Transparent electrodes 220a, 220b and 220c are selectively biased to selectively allow the light from the backlight source to pass the EOLS during a frame time.

In one embodiment according to the present invention, transparent electrodes 220a, 220b and 220c are sequentially biased. In another embodiment, transparent electrodes 220a, 220b and 220c are biased at a same time.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A liquid crystal display (LCD) comprising:
a backlight source;
an electro-optical light shutter (EOLS) including a plurality of regions arranged in a pattern, and during a frame time controlling light from the backlight source to pass the regions in a display time that allows the LCD to display an image; and
an LCD panel disposed to sandwich the EOLS with the backlight source receiving the light passing through the EOLS to display the image.

2. The display of claim 1, the EOLS controlling the light from the backlight source to pass each of the regions in sequence.

3. The display of claim 1, the EOLS controlling the light from the backlight source to pass each of the regions at a same time.

4. The display of claim 1, the EOLS further comprising:
a first substrate;
a first electrode layer on the first substrate further comprising a plurality of transparent electrodes formed in parallel to each other;
a second substrate opposing the first substrate;
a second electrode layer on the second substrate; and
a liquid crystal (LC) layer between the first and second electrode layers.

5. The display of claim 4, the first and second electrode layers further comprising indium tin oxide.

6. The display of claim 4, the LC layer further comprising ferroelectric LC.

7. The display of claim 4, the EOLS further comprising a polarizer on which the first substrate is disposed.

8. The display of claim 4, the EOLS further comprising:
a first polarizer on which the first substrate is disposed; and
a second polarizer on which the second substrate is disposed.

9. A liquid crystal display (LCD) comprising:
a first polarizer;
a first substrate on the first polarizer;
a first electrode layer on the first substrate further comprising a plurality of transparent electrodes formed in parallel to each other;
a second substrate opposing the first substrate;
a second electrode layer on the second substrate;
a first liquid crystal (LC) layer between the first and second electrode layers;
a second polarizer on the second substrate;
a third substrate over the second polarizer;
a second LC layer between the second polarizer and the third substrate; and
a third polarizer on the third substrate.

10. The display of claim 9, the first and second electrode layers further comprising indium tin oxide.

11. The display of claim 9, the third substrate further comprising a color-filter-on-array (COA) substrate.

12. A liquid crystal display (LCD) comprising:
a first polarizer;
a first substrate on the first polarizer;
a first electrode layer on the first substrate further comprising a plurality of transparent electrodes formed in parallel to each other;
a second substrate opposing the first substrate;
a second electrode layer on the second substrate;
a first liquid crystal (LC) layer between the first and second electrode layers;
a second polarizer between the first LC layer and the second electrode layer;
a third substrate over the second substrate;
a second LC layer between the second and third substrates; and
a third polarizer on the third substrate.

13. The display of claim 12, the first substrate further comprising plastics.

14. The display of claim 12, the first and second electrode layers further comprising indium tin oxide.

15. The display of claim 12, the third substrate further comprising a color-filter-on-array (COA) substrate.

17. A method of operating a liquid crystal display (LCD) comprising:
providing a backlight source;
emitting light from the backlight source;
providing an electro-optical light shutter (EOLS) including a first substrate, a first electrode layer on the first substrate further comprising a plurality of transparent electrodes formed in parallel to each other, a second substrate opposing the first substrate, a second electrode layer on the second substrate, and a liquid crystal (LC) layer between the first and second electrode layers; and
selectively biasing the transparent electrodes to selectively allow the light from the backlight source to pass the EOLS during a frame time.

18. The method of claim 17 further comprising sequentially biasing the transparent electrodes.

19. The method of claim 17 further comprising biasing the transparent electrodes at a same time.

20. The method of claim 17 further comprising forming the first and second electrode layers with indium tin oxide.
